(19) United States
(12) Patent Application Publication
(10) Pub. No.: US 2012/0040100 A1
(43) Pub. Date: Feb. 16, 2012

(54) SOLUTION DEPOSITION PLANARIZATION METHOD

(75) Inventors: Vladimir Matias, Santa Fe, NM (US); Christopher J. Sheehan, Santa Fe, NM (US); Jon Fredrick Ihlefeld, Albuquerque, NM (US); Paul Gilbert Clem, Albuquerque, NM (US)

(73) Assignee: Los Alamos National Security, LLC, Los Alamos, NM (US)

(21) Appl. No.: 13/168,093

(22) Filed: Jun. 24, 2011

Related U.S. Application Data
(60) Provisional application No. 61/359,733, filed on Jun. 29, 2010.

(51) Int. Cl. B05D 1/38; B05D 3/02

(52) U.S. Cl. 427/372.2

(57) ABSTRACT

A process for planarizing a substrate involves applying a coating of a first solution of yttrium oxide precursor to a rough substrate surface and heating to remove solvent and convert the yttrium oxide precursor to yttrium oxide. This is repeated with the first solution and then with the second solution. A final surface roughness less than 1 nm RMS may be obtained. In addition, a process for preparing a layered structure includes solution deposition planarization of a rough substrate using different concentrations of metal oxide precursor to provide a metal oxide surface having a surface roughness, and then depositing MgO by IBAD (ion beam assisted deposition). A benefit of a better in plane MgO texture was observed for lower molarities, and when two solutions of different concentrations was employed for coating the rough substrate prior to IBAD-MgO.

### RELATED APPLICATIONS

This application claims the benefit of U.S. Provisional Application No. 61/359,733, entitled “Substrates for Layered Superconductors,”, filed Jun. 29, 2010, which is incorporated by reference herein.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to a solution deposition planarization method for providing a substrate with a very smooth surface.

### BACKGROUND OF THE INVENTION

Mechanically flexible substrates for thin films are growing in popularity for electronic devices such as displays, printed circuit boards, solar cells, batteries, and high temperature superconducting coated conductors (HTSCCs). Flexible substrates are light, and they offer other advantages of having large areas with small volumes, varying form factors, and a reduction of manufacturing costs when materials are processed roll to roll. Flexible substrates, however, may not have the surface smoothness needed for optimal performance. The preparation of practical, layered HTSCCs, for example, requires a very smooth surface for deposition of the superconductor. Ion-beam-assisted deposition (IBAD) texturing is used to create a biaxially textured (crystal-aligned) MgO layer for epitaxial growth of a highly aligned superconductor. The biaxially-textured MgO layer must be very thin, so an extremely smooth substrate is needed for the MgO layer. Thus, for practical implementation of HTSCCs, an inexpensive and fast process to produce smooth substrates for IBAD-MgO textured layers is needed. Mechanical polishing provides a smooth enough substrate surface but may not be practical for long lengths and/or large areas because mechanical polishing is expensive and time consuming. Electropolishing provides a fast process for preparing smooth substrates, but is limited to a few metal alloys, requires expensive starting materials, and generates toxic acid waste.

An efficient and inexpensive process that transforms any rough substrate surface into a surface smooth enough for an IBAD-MgO textured layer is desirable. Generally, a surface roughness RMS of 1 nm or less (on a 5×5 μm scale) is required for high quality IBAD-MgO layer.

An object of the invention is to provide an inexpensive and efficient process for substrate planarization that does not involve polishing but results in a surface that is smooth enough for an IBAD-MgO textured layer for subsequent deposition thereon of a superconductor.

### SUMMARY OF THE INVENTION

To achieve the foregoing and other objects, and in accordance with the purposes of the present invention, as embodied and broadly described herein, the present invention provides a process for planarizing a substrate. The process includes providing a substrate having a surface roughness of at least 3 nm RMS (root mean square). The substrate may have a much rougher surface, such as surface roughness of at least 20 nm RMS. The process also includes providing a first solution having a first concentration of yttrium oxide precursor in a solvent, and applying a coating of the solution to the rough surface. The coated substrate is heated under conditions sufficient to evaporate the solvent and convert the solution of yttrium oxide precursor to a layer of yttrium oxide on the substrate. The steps of applying a coating of the first solution and then heating are repeated to provide a plurality of layers of yttrium oxide, including a surface roughness less than 3 nm RMS but greater than 1 nm RMS (root mean square) on a 5 by 5 μm scale A second solution comprising a second concentration of yttrium precursor is also provided, the second concentration of the yttrium precursor being lower than the first concentration, and a coating of the second solution is applied on the layer of yttrium oxide. The now coated substrate is heated to evaporate the solvent and leave another layer of yttrium oxide on the substrate. The steps of applying a coating of the second solution and heating are repeated until a planarized substrate having plurality of layers of yttrium oxide deposited thereon is produced with a surface roughness less than 1 nm RMS.

The above method above can be adapted by replacing yttrium oxide with another metal oxide. For example, rare earth metal oxides may be deposited.

The invention also includes a method for preparing a layered article. The method includes providing a substrate having a rough surface, providing a first solution comprising a first concentration of a metal oxide precursor in a solvent, applying a coating of the solution to the rough surface, heating the coated substrate under conditions sufficient to evaporate the solvent and convert the solution of metal oxide precursor to a layer of metal oxide on the substrate, repeating the steps of applying a coating of the first solution to the rough surface and heating, thereby forming a plurality of layers of metal oxide on the substrate. The method also includes providing a second solution comprising a second concentration of metal oxide precursor, the second concentration lower than the first concentration, applying a coating of the second solution on the layer of metal oxide, heating the coated substrate to evaporate the solvent and leave a layer of metal oxide on the substrate, and repeating the steps of applying a coating of the second solution and heating. Then a layer of IBAD-MgO is deposited on the metal oxide.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1a shows a cross sectional view of a transmission electron micrograph (TEM) of a substrate coated with layers of yttrium oxide according to an embodiment. An IBAD-MgO layer is on the topmost yttrium oxide layer, a SrTiO₃ buffer layer on the IBAD-MgO layer, and YBCO superconductor layer is on top of the IBAD-MgO layer. FIG. 1b is a higher magnification image of a portion of FIG. 1a that shows individual layers of yttrium oxide in more detail.

FIG. 2 shows a plot of RMS roughness as a function of the number of SDP coatings of an embodiment process using a 0.08 M solution of yttrium oxide precursor and a 0.04 M solution of the yttrium oxide precursor.

FIG. 3 shows a plot of RMS roughness on a 5×5 micrometer area as a function of the number of SDP coatings for a 0.4 M solution of yttrium oxide precursor followed by a 0.08 M solution of the yttrium oxide precursor.

FIG. 4 shows a plot of MgO texture as a function of the number of SDP coatings for two solutions. Solid symbols represent average out-of-plane texture and open symbols represent the in-plane texture.

FIG. 5a shows a plot of out of plane texture of IBAD-MgO vs. RMS roughness, and FIG. 5b shows a ploy of in plane texture of IBAD-MgO vs. RMS roughness, wherein for both FIGURES the IBAD-MgO is deposited on (i) a substrate planarized by SDP using a 0.4 M solution of yttrium acetate (black squares), (ii) a substrate planarized by SDP using a 0.08 M solution of yttrium acetate (gray squares), and (iii) a substrate planarized by SDP using a two-solution process wherein the first solution is 0.4 M yttrium acetate and the second solution is 0.08 M yttrium acetate (diamond), and (iv) a substrate planarized by mechanical polishing (open black circles). The mechanically polished samples data is from Matias et al. in Mater. Res. Soc. Symp. Proc., Barnes et al. editors, vol. 1001E, Warrendale, Pa., 2007, No. 100′-M04-02. The in plane texture is superior for the process involving the two solutions.

### DETAILED DESCRIPTION

The invention relates to a chemical solution deposition process to planarize a rough substrate surface efficiently, inexpensively, and in long lengths of substrate. Instead of removing material to planarize a substrate having a rough surface, as a polishing method does, layers are added that are smoother than the underlying rough substrate surface. The method is sometimes referred herein as Solution Deposition Planarization (SDP). The method has been shown to produce a surface roughness under 1 nm RMS starting with a substrate surface that is rougher by two orders of magnitude. For the preparation of layered structures that support IBAD-MgO, the additional layers that planarize the substrate may also serve the dual purpose as an interdiffusion barrier.

An aspect of this invention applies to the formation of a plurality of layers of yttrium oxide on a rough substrate surface to planarize the surface. This involves applying a coating of a first solution of yttrium oxide precursor to the rough surface. The precursor may be yttrium acetate, or some other yttrium containing precursor that converts to the oxide upon heating in an oxidizing environment. The coated substrate is heated under conditions sufficient to evaporate the solvent and convert the solution of yttrium oxide precursor to a layer of yttrium oxide on the substrate. These steps of applying a coating of the first solution and heating are repeated to provide a plurality of layers of yttrium oxide, the plurality with a surface roughness greater than 1 nm RMS. At this stage, the surface roughness is preferably greater than 1 nm RMS but less than 5 nm RMS, or less than 4 nm RMS, or less than 3 nm RMS, or less than 2 nm RMS. Once this level of roughness is achieved, a coating of a second solution is then applied to the topmost yttrium oxide layer, the second solution having a concentration of the yttrium oxide precursor that is less than the concentration of precursor in the first solution. The substrate is heated to evaporate the solvent and leave a second layer of yttrium oxide. The steps of applying a coating of the second solution and heating are repeated until a planarized substrate having plurality of layers of yttrium oxide deposited thereon is produced, the surface roughness now less than 1 nm RMS. It was found that when the concentration of yttrium oxide precursor is less for the second solution that the first, after forming a plurality of layers on the substrate, a surface roughness less than 1 nm RMS, less than 0.9 nm RMS, less than 0.8 nm RMS, less than 0.7 nm RMS, and even less than 0.6 nm RMS was achieved. In an embodiment, a surface roughness between 0.6 nm RMS and 0.5 nm RMS was realized using this method when the concentration of the first solution was 0.4 M and the concentration of the second solution was 0.08 M when the yttrium oxide precursor was yttrium acetate.

The method is applied to substrates with rough surfaces. By rough, the surface has a surface roughness of at least 20 nanometers (nm) RMS (root-mean-squared). In some embodiments, the surface roughness is at least 30 nm RMS. In some embodiments, the surface roughness is at least 40 nm RMS. In other embodiments, the surface roughness is at least 50 nm RMS.

The substrates may be metal substrates, ceramic substrates, or some other substrate having a rough surface. In an embodiment, a metal or metal alloy, such as a hastelloy may be a substrate. Silicon may be a substrate. In an embodiment, a stainless steel may be a substrate. In another embodiment, silica may be a substrate. In another embodiment, alumina may be a substrate. In another embodiment, silicon nitride may be a substrate.

The substrates are flexible. For the purposes of preparing flexible layered coated superconductors, the substrates should be long, at least 5 meters in length. Substrates having a length greater than 10 meters, greater than 25 meters, greater than 50 meters, greater than 100 meters, greater than 500 meters, greater than 1000 meters, greater than 5000 meters, greater than 10,000 meters, greater than 100,000 meters, greater than 250,000 meters, greater than 500,000 meters, greater than 1,000,000 meters, and so on, may be prepared using the present method. There is in fact, no limit to the length of the substrate having a rough surface that can be used with the present method.

It should be understood that the invention does not involve polishing the substrate surface to eliminate surface roughness. The invention applies to substrates with rough surfaces that have not been subjected to mechanical polishing.

The rough substrate surface prior to planarization is contoured with many peaks and valleys. Upon coating with a liquid solution, the surface tension of the liquid planarizes the contoured surface resulting in thicker regions over the valleys and thinner regions over the peaks. After drying and pyrolysis, the coating shrinks following the original substrate contours, with a decrease in roughness compared to the underlying substrate. By repeating the process a number of times, further reduction in roughness is obtained.

In an embodiment, Hastelloy C-276 metal tape, 0.1 mm thick, was used as the substrate. In an embodiment, the metal tape was 10 mm wide and about 5 meters long. In an embodiment the starting roughness was 33 nm RMS (50 micrometer scale). In another embodiment, the starting roughness was 21 nm (5 micrometer scale).

Solution Deposition Planarization (SDP) coatings of yttria (Y₂O₃) were done using dip coating in a continuous tape loop coater where the tape is dipped into a bath and then heated repeatedly. A diagram of the apparatus can be found in FIG. 3 of Hänisch et al. entitled “Stacks of YBCO Films Using Multiple IBAD Templates,” IEEE Transactions on Applied Superconductivity, June 2007, vol. 17, no. 2, pp. 3577-3580, hereby incorporated by reference. The dip coating bath included a submerged idler and the tape exits the free liquid surface away from the idler surface. The tape pull speed was 200 mm/min. The tape then entered a flow-controlled environment during the solvent drying stage to reduce turbulence. Subsequently, yttria conversion and hydrocarbon oxidation took place in a 22 mm OD, 610 mm long, quartz tube at a temperature of 515±10° C. Dry compressed air flow at 11.8 L/min ensured sufficient oxidation and removal of byproducts within the tube.

Multiple passes were performed by continuous operation of the coater. Solutions of 0.08 M and 0.40 M concentration were prepared by mixing yttrium (III) acetate tetrahydrate in a solvent of methanol and diethanolamine. The solutions were filtered using a 0.22 micrometer polytetrafluoroethylene syringe filter prior to use.

Atomic force microscopy (AFM) and profilometry were used to measure the surface roughness and thin film thickness after every 5 SDP coatings. AFM scans were taken over 5×5 micrometer and 50×50 micrometer areas for 5 points and results were averaged. A second order flattening procedure was used to remove the background height in the AFM scans.

Following SDP, a biaxially-textured layer of IBAD-MgO was applied. This procedure took place in a vacuum chamber. Tape samples from the SDP were spliced together. All the depositions were done in one IBAD pass and run. An ion beam of Ar at 1000 volts (V) was used for assist at 45° to the substrate normal. MgO was deposited by electron-beam sublimation at a rate of 0.45 nm/s. The MgO deposition time was 50 seconds. A homoepitaxial MgO layer of 150 nm was deposited in situ at a rate of 8 nanometers per second (nm/s) at approximately 500° C. Samples were analyzed by x-ray diffraction to determine the mosaic spreads. The procedure used for the MgO deposition has been described in a paper by Matias et al. entitled “Very Fast Biaxial Texture Evolution Using High Rate Ion-Beam-Assisted Deposition of MgO,” J. Mater. Res., January 2009, vol. 24, p. 125-129, incorporated by reference herein.

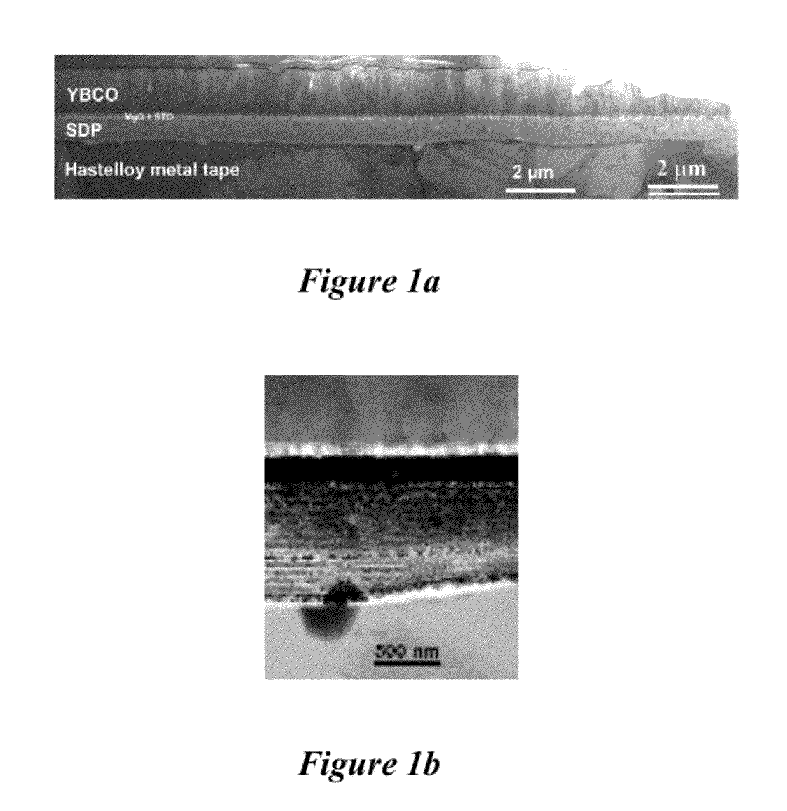

FIG. 1a-b shows cross sectional transmission electron microscope (TEM) images of the Hastelloy tape after 15 SDP coatings of yttrium oxide, a layer of IBAD-MgO on the yttrium oxide, and YBCO on the IBAD-MgO layer. The planarization effect is noticeable, particularly in FIG. 1b where the individual yttrium oxide layers are more clearly separated from each other. Furthermore, particularly in FIG. 1b, one can see that the SDP is tolerant of substrate defects as it encapsulates them and shows no sign of the defect at the interface with the IBAD-MgO layer.

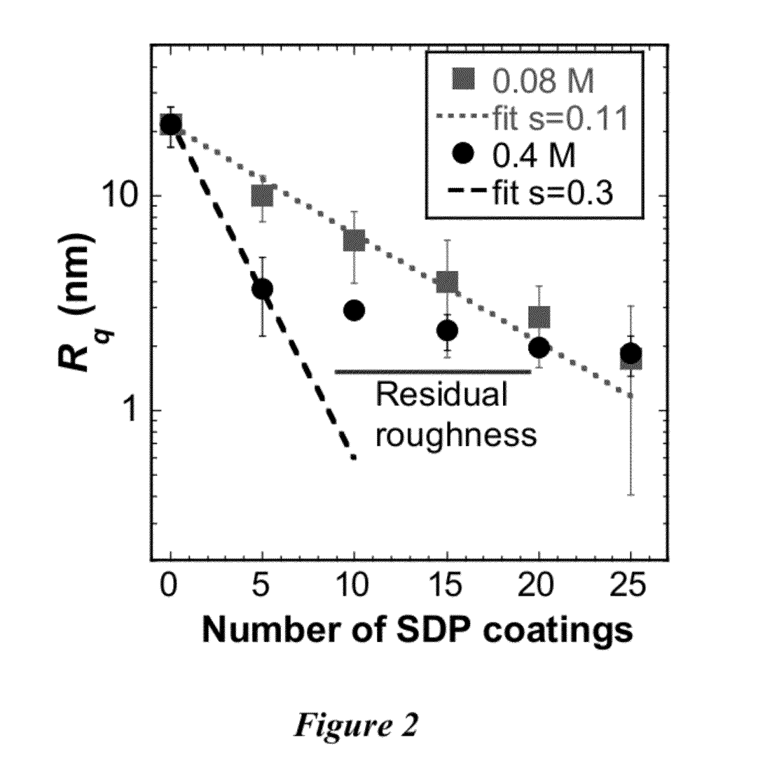

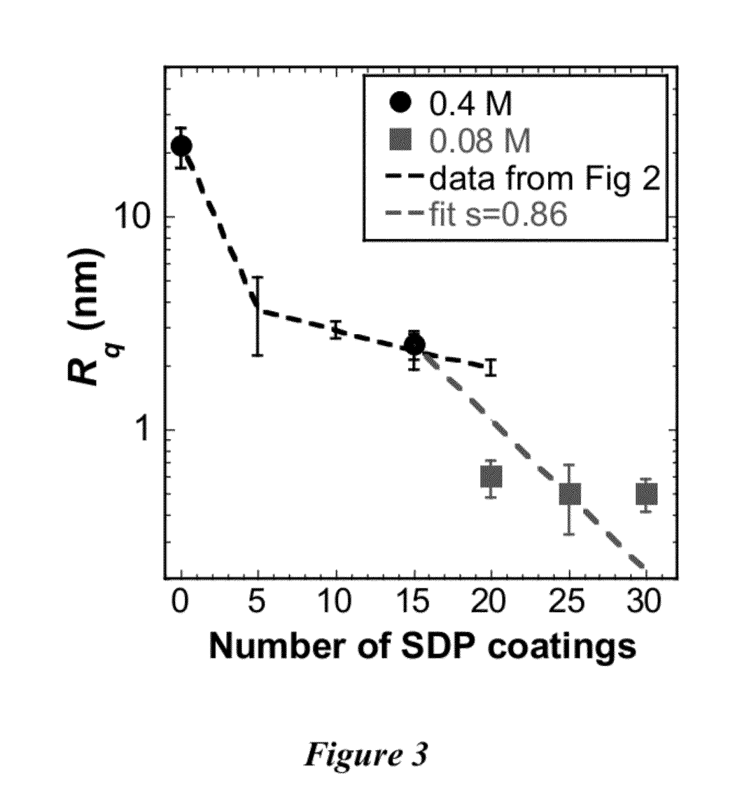

The RMS roughness over a 5×5 micrometer area was used to characterize the surfaces at each stage of deposition. The data after sequential coatings are shown in FIG. 2 for the two different solutions, 0.08 M and 0.4 M. The lower molarity solution has the slower planarization effect of the two solutions but its effectiveness persists for more passes than the higher molarity solution, which appears to saturate at a roughness of about 1.5 nm RMS. At 25 coatings, the two solutions yield approximately the same 5 micrometer roughness. However, 15 coatings of the 0.08 M solution is still rougher on this scale than only 5 coatings of the 0.4 M solution.

The results were analyzed using a simple model for the decrease in roughness resulting from the amount of shrinkage in each coating. The liquid layer is assumed to be perfectly flat. As the liquid evaporates and the coating shrinks into a solid and then converts to the oxide film, the films regain some of the original roughness, but diminished in magnitude. The remaining roughness can be modeled from the shrinkage of the film. Shrinkage (s) is defined as follows:

s=1−t_{fin}/tᵢₙᵢₜ

where t_{fin} is the thickness that remains after pyrolysis and tᵢₙᵢₜ is the thickness of the last liquid state that retains a flat surface. The remaining roughness (R_{fin}) is then

R_{fin}=Rᵢₙᵢₜs,

where Rᵢₙᵢₜ is the initial roughness. If there were no shrinkage, the resulting surface would be perfectly flat with no roughness. From this simple model, RMS roughness is R_{q} wherein

R_{q}=R₀sⁿ

where n is the number of coatings and R₀ is the initial RMS roughness of the substrate. The dashed lines in FIG. 2 are the fits to the initial slopes of the data for both solutions. For the 0.4 M solution, the data immediately fall off the fitted curve. For the 0.08 M solution, the data deviate from the fit at a higher number of coatings.

We postulate that the roughness of the SDP is limited by the residual roughness of each solution deposited film. AFM images indicate a granular structure to the films that is dependent on the film thickness. For the 0.08 M solution film thickness was measured to be 12 nm±2 nm and for the 0.4 M solution 62 nm±5 nm. The ratio of the film thicknesses is approximately 5, which is close to the ratio of the molarities of the two solutions. For the 0.4 M solution SDP, the data show the residual roughness appears to be 1.5 nm or about 2.5% of the film thickness. The same relative fraction extrapolated to the 0.08 M solution would yield a residual roughness of about 0.4 nm. In an attempt to verify our prediction, a second set of experiments was performed where we first coated with the 0.4 M solution and then with the 0.08 solution. Results are shown in FIG. 3. After 15 coatings with the 0.4 M solution of yttrium oxide precursor, the RMS roughness was reduced to 2.5 nm. Further coatings with the 0.08 solution of yttrium oxide precursor reduced the roughness to about 0.5 nm where it saturated.

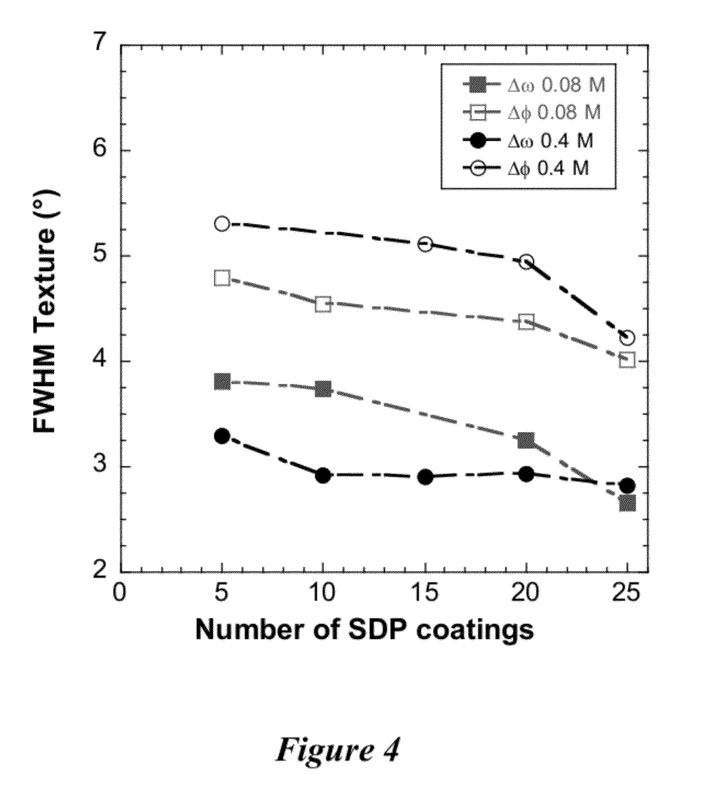

IBAD texture measurements were performed on the series of SDP coatings with the two different molarity solutions. The resulting MgO in-plane and out-of-plane texture data are shown in FIG. 4, which is a plot of MgO texture as a function of the number of SDP coatings for the two solutions. Square symbols represent average out-of-plane texture and circles represent in-plane texture. The inset shows the out-of-plane texture as a function of RMS roughness together with the data taken from Matias et al. in Mater. Res. Soc. Symp. Proc., edited by Barnes et al., vol. 1001E, Warrendale, Pa., 2007, No. 1001-M04-02. A decrease in the FWHM for the mosaic spreads as a function of SDP coatings. The out of plane texture (lower part of the graph) correlates well with the RMS roughness as measured by the AFM on a 5×5 micrometer area. The inset of FIG. 4 plots these out-of-plane data versus roughness with the previously published data for mechanically polished samples described in Matias et al. in Mater. Res. Soc. Symp. Proc., edited by Barnes et al., vol. 1001E, Warrendale, Pa., 2007, No. 1001-M04-02. This agreement was good, but the in-plane texture did not correlate well with only the roughness values. From this data, the 0.08 M solution had better in-plane texture than the 0.04 M solution, even though the roughness numbers were reversed (see FIG. 2).

The SDP prepared substrates were used for creating IBAD templates for superconducting coated conductors. In an embodiment, a layer of YBa₂Cu₃O₇ (YBCO) of 1-3 micrometers in thickness was deposited on the IBAD template. A number of different YBCO deposition techniques were used successfully on these templates, including pulsed laser deposition (PLD), reactive coevaporation (RCE), and MOCVD. FIG. 1a shows a 1.2 micrometer YBCO layer deposited by PLD on the IBAD/SDP template with a SrTiO3 buffer layer. For this sample, the critical current, J_{c}, at 75K in self field (SF) was measured to be 2.85 MA/cm². For comparison, a RCE YBCO film of 1 micrometer was deposited on an IBAD/SDP template and the J_{c} at 75K (SF) was 4 MA/cm2 without a buffer layer. These Jc values match or exceed the best undoped YBCO samples made by PLD on single crystal substrates (see: Foltyn et al., Nat. Mater., 2007, vol. 6, p. 631).

Another aspect of this invention relates to other benefits that are afforded by using a rough substrate and coating with a first solution and then with a second solution. A benefit relates to certain properties of an IBAD-MgO layer deposited on the topmost of the metal oxide layers. A surface roughness less than 1 nm RMS is not required.

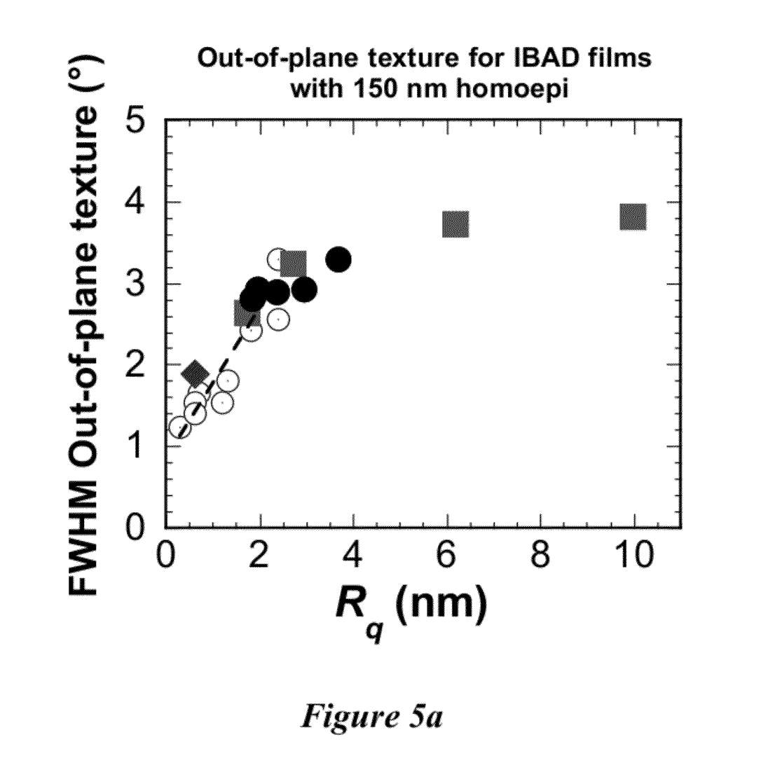

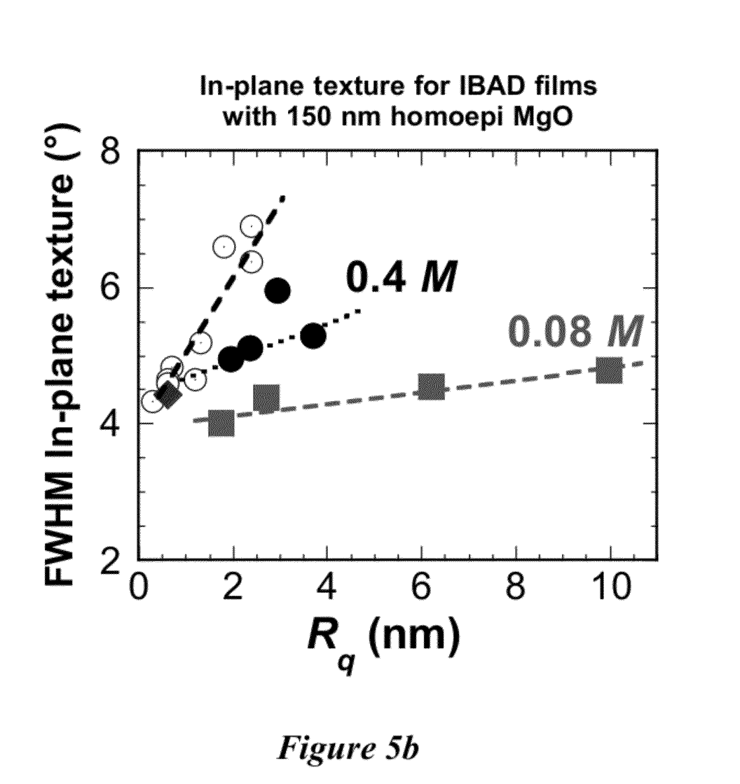

Certain benefits in grain alignment were found when IBAD-MgO was deposited on yttrium oxide, which was applied by solution deposition planarization on a rough substrate, wherein a two solution process was used for deposition of the yttrium oxide. In particular, it was found that the in-plane texture of an IBAD-MgO layer deposited on the topmost layer formed from a coating process using two solutions of yttrium oxide was superior compared to a process involving the use of only one 0.4 M solution. FIG. 5a shows a plot of out of plane texture of IBAD-MgO vs. RMS roughness, and FIG. 5b shows a plot of in plane texture of IBAD-MgO vs. RMS roughness. The plots compare the in plane texture of the IBAD-MgO layers deposited on a variety of surfaces. One of the surfaces is a mechanically polished substrate (open circles). Another surface is formed when a 0.4 M solution of yttrium acetate was used for solution deposition planarization (red squares), and the surface roughness RMS is shown on the x-axis. Another surface is formed when a 0.08 M solution of yttrium acetate was used for solution deposition planarization (gray squares), the surface roughness also shown on the x-axis. The in plane texture of the IBAD-MgO layer appears to be better for the lower molarity solution, and is best when two solutions (diamond), a first solution of 0.4 M, and a second solution of 0.08 M, are used. The plot also indicates that the lower molarities (0.08 M) provide a better in plane texture than the higher molarity coating (0.4 M). At higher surface roughness, the lower molarity coating is a good choice.

Thus, the in plane texture for IBAD-MgO deposited on yttrium oxide was best for a process wherein a first solution of 0.4 M yttrium oxide precursor (yttrium acetate, for example) was used first, and then a second solution of lower molarity (0.08 M yttrium oxide precursor, yttrium acetate).

In summary, the invention of solution deposition planarization may be used for smoothing substrates in long lengths with resulting RMS roughness less than 1 nm. With the appropriate solution deposited layers, these planarized substrates can be used directly for IBAD-MgO texturing with very high quality and then for deposition of very high Jc-cuprate superconductors.

Although the present invention has been described with reference to specific details, it is not intended that such details should be regarded as limitations upon the scope of the invention, except as and to the extent that they are included in the accompanying claims. For example, metal oxides besides yttrium oxide may be used instead of yttrium oxide, or in mixtures with yttrium oxide. These other metal oxides include aluminum oxide, titanium oxide, zirconium oxide, hafnium oxide, and rare earth metal oxides such as erbium oxide. A mixture of aluminum oxide with yttrium oxide may also be used. In addition, the invention has thus far been described using two solutions of two different concentrations. It should be understood that the method may be expanded by using three solutions of different molarities, wherein the first solution has a concentration greater than the second solution and the second solution has a concentration greater than the third solution. The method can be expanded to the use of four solutions wherein the first has the highest concentration of the metal oxide precursor, the second having a lower concentration than the first solution with the same precursor, the third solution having a concentration lower than the second, and the fourth a lower concentration than the third. This can be expanded for any number ‘n’ of solutions where the concentration decreases sequentially to the nth solution which has the lowest concentration of the metal oxide precursor. The invention also applies the preparation of metal oxynitride coatings.

In another embodiment, titanium dioxide and zirconium dioxide coatings were prepared to planarize unpolished aluminum plate to enable integrated electronics deposition atop the insulating TiO₂ or ZrO₂ top surface. Solutions of 0.15 M concentration and then 0.05M concentration (a) titanium isopropoxide in isopropanol or (b) zirconium butoxide in isopropanol were subsequently dip coated, using eight layers of each concentration, dried at 300° C. for 1 minute, and subsequently annealed in air at 450° C. for 10 minutes, atop 30 cm wide aluminum plates. The coatings reduced the initial 5 micron-scale roughness to less than 100 nm RMS after annealing. The TiO₂ or ZrO₂ coated aluminum was subsequently used as an insulating substrate for printed electronic circuit boards, in which the deposited conductive metal traces were then electrically insulated from the rough aluminum substrate via the planarization layers.

What is claimed is:

1. A process for planarizing a substrate, comprising:
providing a substrate having a surface roughness greater than 3 nm RMS,
providing a first solution comprising a first concentration of yttrium oxide precursor in a solvent,
applying a coating of the solution to the rough surface,
heating the coated substrate under conditions sufficient to evaporate the solvent and convert the solution of yttrium oxide precursor to a layer of yttrium oxide on the substrate,
repeating the steps of applying a coating of the first solution to the rough surface and heating, thereby forming a plurality of layers of yttrium oxide on the substrate, the plurality comprising a surface roughness of less than 3 nm RMS but greater than 1 nm RMS,
providing a second solution comprising a second concentration of yttrium precursor, the second concentration lower than the first concentration,
applying a coating of the second solution on the layer of yttrium oxide,
heating the coated substrate to evaporate the solvent and leave a second layer of yttrium oxide on the substrate,
repeating the steps of applying a coating of the second solution and heating until a planarized substrate having plurality of layers of yttrium oxide deposited thereon with a surface roughness less than 1 nm RMS.

2. The process of claim 1, wherein the first concentration of yttrium oxide precursor is 0.4M.

3. The process of claim 1, wherein the second concentration of yttrium oxide precursor is 0.08M.

4. The process of claim 1, wherein the substrate has a surface roughness of at least 20 nm RMS.

5. The process of claim 1, wherein the substrate has a surface roughness of at least 30 nm RMS.

6. The process of claim 1, wherein the substrate has a surface roughness of at least 40 nm RMS.

7. The process of claim 1, wherein the substrate has a surface roughness of at least 50 nm RMS

8. The process of claim 1, wherein the surface roughness comprising yttrium oxide is less than 0.9 nm RMS.

9. The process of claim 1, wherein the ratio of the concentration of the first solution to the concentration of the second solution is at least 2.0.

10. The process of claim 1, wherein the ratio of the concentration of the first solution to the concentration of the second solution is at least 3.0.

11. The process of claim 1, wherein the ratio of the concentration of the first solution to the concentration of the second solution is at least 4.0.

12. The process of claim 1, wherein the ratio of the concentration of the first solution to the concentration of the second solution is at least 5.0.

13. The process of claim 1, wherein the surface roughness comprising yttrium oxide is less than 0.6 nm RMS.

14. A process for planarizing a substrate, comprising:
providing a substrate having a rough surface,
providing a first solution comprising a first concentration of a metal oxide precursor in a solvent, the metal oxide chosen from the group of rare earth oxides, silicon oxide, hafnium oxide, titanium oxide, zirconium oxide, aluminum oxide, and a mixture of yttrium oxide and aluminum oxide,
applying a coating of the solution to the substrate surface,
heating the coated substrate under conditions sufficient to evaporate the solvent and convert the solution of metal oxide precursor to a layer of metal oxide on the substrate,
repeating the steps of applying a coating of the first solution to the substrate surface and heating, thereby forming a plurality of layers of metal oxide on the substrate, the plurality comprising a surface roughness of greater than 1 nm RMS,
providing a second solution comprising a second concentration of yttrium precursor, the second concentration lower than the first concentration,
applying a coating of the second solution on the layer of metal oxide,
heating the coated substrate to evaporate the solvent and leave a second layer of metal oxide on the substrate,
repeating the steps of applying a coating of the second solution and heating until a planarized substrate having plurality of layers of metal oxide deposited thereon with a surface roughness less than 1 nm RMS.

15. The method of claim 14, wherein said rare earth oxides are chosen from erbium oxide.

16. A method for preparing a layered article, comprising:
providing a substrate having a rough surface,
providing a first solution comprising a first concentration of a metal oxide precursor in a solvent,
applying a coating of the solution to the rough surface,
heating the coated substrate under conditions sufficient to evaporate the solvent and convert the solution of metal oxide precursor to a layer of metal oxide on the substrate,
repeating the steps of applying a coating of the first solution to the rough surface and heating, thereby forming a plurality of layers of metal oxide on the substrate,
providing a second solution comprising a second concentration of metal oxide precursor, the second concentration lower than the first concentration,
applying a coating of the second solution on the layer of metal oxide,
heating the coated substrate to evaporate the solvent and leave a layer of metal oxide on the substrate,
repeating the steps of applying a coating of the second solution and heating,
depositing a layer of biaxially-textured IBAD-MgO on the metal oxide.

17. The method of claim 16, wherein the metal oxide is yttrium oxide, a rare earth metal oxide, or a mixture of yttrium oxide and aluminum oxide.

18. The method of claim 16, wherein the first solution comprises 0.4 M yttrium acetate.

19. The method of claim 17, wherein the second solution comprises 0.08 M yttrium acetate.
